(19) United States
(12) Patent Application Publication
(10) Pub. No.: US 2025/0220461 A1
(43) Pub. Date: Jul. 3, 2025

(54) USER EQUIPMENT BAND SELECTION FOR CELLULAR PERFORMANCE

(71) Applicant: Samsung Electronics Co., Ltd., Suwon-si (KR)

(72) Inventors: Vutha Va, Plano, TX (US); Priyabrata Parida, Dallas, TX (US); Anum Ali, Frisco, TX (US); Boon Loong Ng, Plano, TX (US); Yuqiang Heng, Plano, TX (US)

(21) Appl. No.: 18/922,311

(22) Filed: Oct. 21, 2024

Related U.S. Application Data
(60) Provisional application No. 63/615,419, filed on Dec. 28, 2023.

(51) Int. Cl. H04W 24/02; H04W 24/10; H04W 74/0833

(52) U.S. Cl. CPC H04W 24/02; H04W 24/10; H04W 74/0833

(57) ABSTRACT

A user equipment (UE) includes a transceiver, and a processor operatively coupled to the transceiver. The processor is configured to detect an occurrent of an event, and determine whether the event is a qualifying event. The processor is also configured to, in response to a determination that the event is a qualifying event, identify, based on a band map and a present location of the UE, an event improvement procedure, and perform the event improvement procedure.

### CROSS-REFERENCE TO RELATED APPLICATION(S) AND CLAIM OF PRIORITY

This application claims priority under 35 U.S.C. § 119 (e) to U.S. Provisional Patent Application No. 63/615,419 filed on filing Dec. 28, 2023. The above-identified provisional patent application is hereby incorporated by reference in its entirety.

### TECHNICAL FIELD

This disclosure relates generally to wireless networks. More specifically, this disclosure relates to user equipment (UE) band selection for cellular performance.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for user equipment (UE) band selection for cellular performance.

In one embodiment, a UE is provided. The UE includes a transceiver, and a processor operatively coupled to the transceiver. The processor is configured to detect an occurrent of an event, and determine whether the event is a qualifying event. The processor is also configured to, in response to a determination that the event is a qualifying event, identify, based on a band map and a present location of the UE, an event improvement procedure, and perform the event improvement procedure.

In another embodiment, a method of operating a UE is provided. The method includes detecting an occurrent of an event, and determining whether the event is a qualifying event. The method further includes, in response to a determination that the event is a qualifying event, identifying, based on a band map and a present location of the UE, an event improvement procedure, and performing the event improvement procedure.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example method for UE data collection according to embodiments of the present disclosure;

FIG. 5 illustrates an example method for map exploitation according to embodiments of the present disclosure;

FIG. 6 illustrates an example method for identifying a cell of interest according to embodiments of the present disclosure;

FIG. 7 illustrates an example method for identifying and registering cells of interest according to embodiments of the present disclosure;

FIG. 8 illustrates an example method for managing location services when in a cell of interest according to embodiments of the present disclosure;

FIG. 9 illustrates an example method for managing operation of proactive band selection according to embodiments of the present disclosure;

FIG. 10 illustrates an example method for proactive band selection according to embodiments of the present disclosure;

FIG. 11 illustrates an example method for band selection for fast RLF recovery according to embodiments of the present disclosure;

FIG. 12 illustrates an example method for early detection of an RLF according to embodiments of the present disclosure;

FIG. 13 illustrates an example method for early HOF detection according to embodiments of the present disclosure;

FIG. 14 illustrates an example method for coverage hole mitigation according to embodiments of the present disclosure; and

FIG. 15 illustrates an example method for UE smart band selection according to embodiments of the present disclosure.

### DETAILED DESCRIPTION

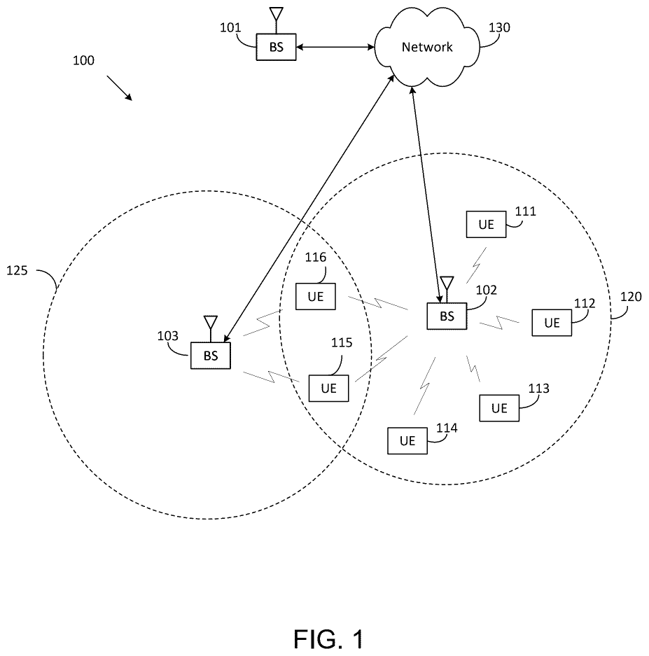

FIGS. 1 through 15, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for UE smart band selection. In certain embodiments, one or more of the gNBs 101-103 includes circuitry, programing, or a combination thereof, to support UE smart band selection in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

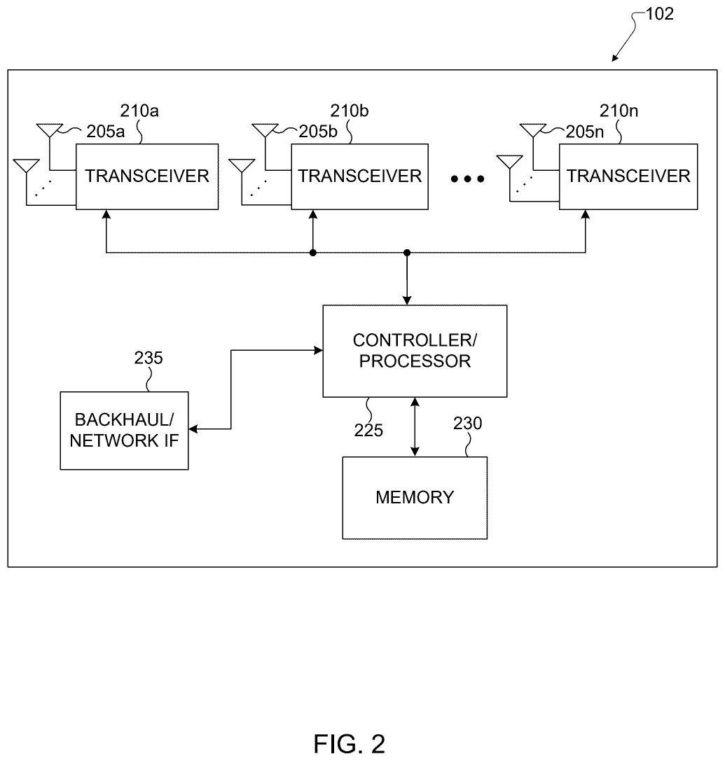

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to support UE smart band selection as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

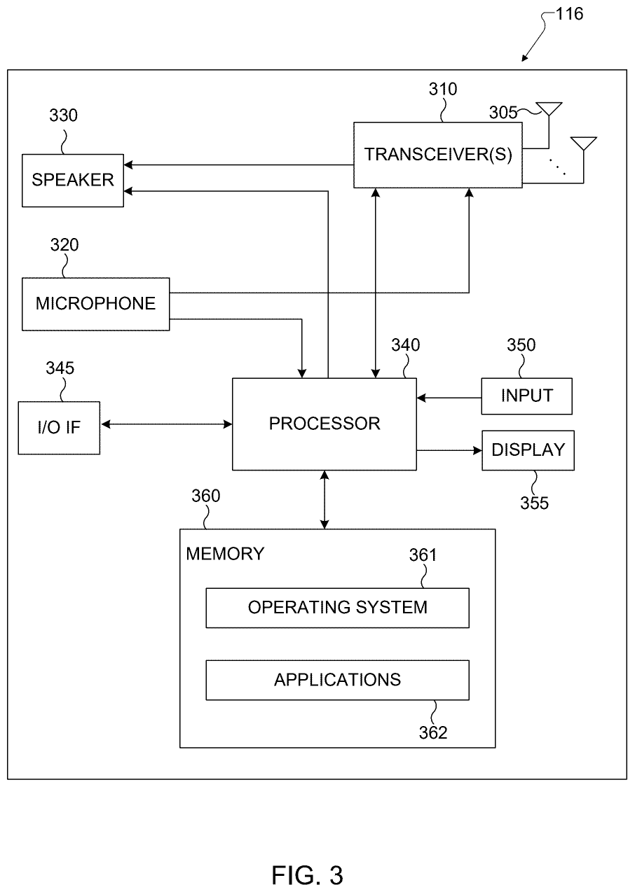

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data). Transceiver 310 may be referred to as a modem.

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for UE smart band selection as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

In cellular networks, a user equipment (UE) may experience poor performance due to non-optimal planning and/or configuration of the network. Such issues tend to be localized to certain geographical areas. For example, there could be a certain street corner where users often experience call drops. By observing past measurement data, locations can be identified that are prone to having performance problems. Further, data collected at those locations may be used to identify better configurations (e.g., selecting better bands that do not lead to a link failure).

The present disclosure provides various embodiments of smart band selection methods for a UE to avoid or mitigate UE performance problems and improve the user experience, for example by:
reducing or avoid connection failures, which may include radio link failure and handover failure (which can cause substantial data interruption and lead to call drops)·
providing fast recovery from connection failure events
identifying coverage holes.

Some embodiments utilize a learning-based approach using data collected by one or more UEs. The collected data can be used to identify problematic locations as well as ways to mitigate/avoid the problem. As described herein, extracted information from the collected data is referred to as a band map or a map. In some embodiments, the learning may be based on an individual UE or an aggregated group of UEs aided by a third entity that helps gather the data from the group of UEs and maintains the map. In some embodiments, a smart band selection method includes a data collection process, and a map exploitation process. In some embodiments, the data collection process is performed concurrently with the map exploitation process.

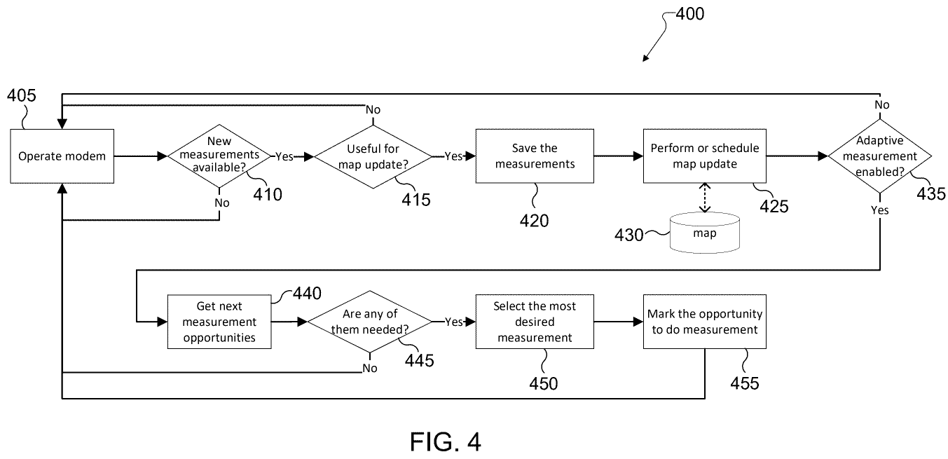

FIG. 4 illustrates an example method for UE data collection 400 according to embodiments of the present disclosure. An embodiment of the method illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a method for UE data collection could be used without departing from the scope of this disclosure.

In the example of FIG. 4, the UE data collection method 400 is a flexible collection method that supports a default and an adaptive approach for data collection. The default data collection approach, which includes steps 405 through 425, considers measurement data that is obtained by the default operations by following all the configurations provided by the network. The adaptive approach, which includes the additional steps 440 through 455 allows some choices of the measurements that the UE can make as needed. Note that the configurations from the network do not dictate all measurements at the UE, and there is some flexibility left to the UE implementation. For example:
The order of the measurements of neighbor cells is not strictly set by the network.
Some rules for radio resource management (RRM) measurements (e.g., inter-frequency) are meant for saving the UE power despite the measurement resources being configured. Thus, the UE can still perform those measurements if the UE wants the measurements and battery power is not a concern at the time of the measurements.

In the example of FIG. 4, method 400 begins at step 405. At step 405, a UE such as UE 116 of FIG. 1 operates its modem (e.g., transceiver[s] 310). With respect to step 405, “operate modem” refers to the default operation of the modem, which may include normal operations of data communications for the user, signaling related control messages to/from the network, as well as various signal quality measurements. For example, the network may configure a UE with a set of measurement objects, where each measurement object tells the UE when and where (i.e., frequency and time slot) to measure signal quality (e.g., RSRP, RSRQ, SNR, SINR, etc.) and when to report the measurements to the network (which could be periodic or event triggered).

At step 410, the UE determines if new measurements are available based on current configurations from the network. If no new measurements are available, the method returns to step 405. Otherwise, if new measurements are available, the method proceeds to step 415.

At step 415, the UE determines if the new measurements are useful for the map. Some examples of checks to determine usefulness include:
Checking validity of the location information: this may include checking if up to date location information is available. For example, the UE may check whether the location information timestamp and the measurement timestamp are within a threshold. The UE may further incorporate a check on the location information uncertainty. In some embodiments, if the location information is too noisy (e.g., an uncertainty estimate is larger than a threshold), the measurement could be deemed invalid. For example, if the location is determined using a global navigation satellite system (GNSS), the GNSS may provide the uncertainty level.
Checking the timestamp of current and previous measurements: a useful map may be obtained without incorporating all available measurements. For example, in a semi-static scenario like an office desk where the user stays at for the most part of the day, there will be a large number of measurements at that location. However, most of the measurements are redundant and saving and/or processing those measurements are an inefficient use of computation and/or storage resources with little to no impact on the map. To avoid such situation, a check to make sure that measurements at the same location are not too close in time can be utilized.

If the UE determines that the measurements are not useful for the map, the method returns to step 405. Otherwise, if the UE determines that measurements are useful for the map, the method proceeds to step 420.

At steps 420 and 425, the UE saves the measurements to a map 430. The measurements may be saved at the time of collection, or saved according to a scheduled map update.

At step 435, the UE determines if adaptive measurement is enabled. If adaptive measurement is not enabled, the method returns to step 405. Otherwise, if adaptive measurement is enabled, the method proceeds to step 440.

At step 440, the UE determines the next measurement opportunities based on current configurations from the network. For example, the UE may check a list of all measurement configurations to identify the next measurement opportunities. In some embodiments, the list may be a list of frequency bands and times where measurements can be conducted. In some embodiments, for example, in a 4G/5G network, RRC messages or system information can be used to convey the measurement configurations to the UE. In some embodiments, the map may include a set of (location, configuration, measurements) tuples. For each location and configuration (which may include frequency band, cell ID, etc.), the UE can compute the uncertainty (e.g., variance or any other metrics for measuring variability in a set of sample data) of the signal quality from the existing measurements collected so far. For map building it may be desirable to minimize the uncertainty. Therefore, higher priority could be given to the configurations with high uncertainty for the location of interest. Other criteria could also be selected, such as to prioritize promising configurations (e.g., frequency bands) over bad ones or just balancing the number of measurements in each configuration. There could be one or multiple measurement opportunities at the same or nearby time slot.

At step 445, the UE checks against the current map to determine if any of the next available opportunities could be useful for updating the map. For example, the UE may check if the uncertainty in the current location is high, and the current location could use more measurements to improve the map data. If none of the next available opportunities are useful, the method returns to step 405. Otherwise, if any of the next available opportunities are useful, the method proceeds to step 450.

At step 450, the UE selects the most desired measurement opportunities (e.g., one with the highest uncertainty in the current map) according to the number of measurements that the UE can afford (e.g., based on the UE's current battery level and/or processing load) and is allowed to perform.

At step 455, the UE marks the selected measurement as the next measurement(s) to be conducted by the modem. For example, the UE may update a list to indicate that the selected measurement is the next measurement.

Although FIG. 4 illustrates one example method for UE data collection 400, various changes may be made to FIG. 4. For example, while shown as a series of steps, various steps in FIG. 4 could overlap, occur in parallel, occur in a different order, occur any number of times, be omitted, or replaced by other steps. For example, while FIG. 4 shows measurement collection and selecting/scheduling the measurements in the same process, measurement collection and selecting/scheduling of measurements could be implemented as independent processes that could be run in parallel.

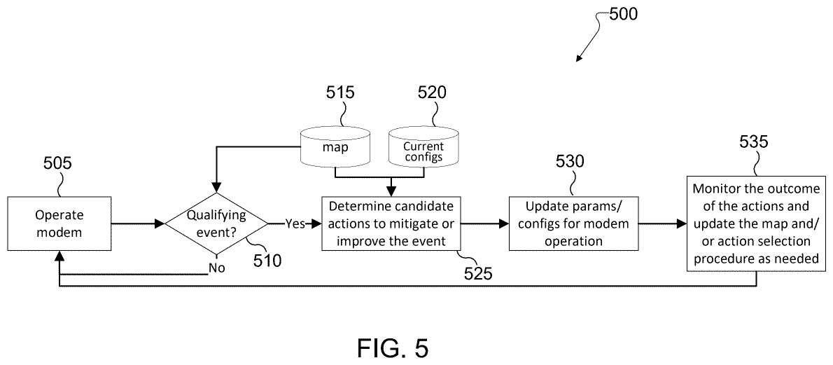

FIG. 5 illustrates an example method for map exploitation 500 according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a method for map exploitation could be used without departing from the scope of this disclosure.

In the example of FIG. 5, method 500 begins at step 505. At step 505, a UE such as UE 116 of FIG. 1 operates its modem (e.g., transceiver[s] 310). Operating the modem at step 505 may be similar as described regarding step 405 of FIG. 4. During step 505, the UE may detect an occurrent of an event.

At step 510, the UE determines if an event detected during operation of the modem is a qualifying event. In some embodiments, the qualifying event is determined based on map 515 and current configurations 520. As described herein, a qualifying event refers to a situation where a map (e.g., map 515) can be used to improve a user experience. Some examples of qualifying events could be a radio link failure (RLF) event, handover (HO) failure event, mobility issues (e.g., frequent ping pong), etc. If the event detected during operation of the modem is not a qualifying event, the method returns to step 505. Otherwise, if the event is a qualifying event, the method proceeds to step 525.

At step 525, the UE utilizes map 515 and current configurations 520 to determine candidate actions that could improve the user experience related to the qualifying event. The candidate actions may also be referred to as event improvement procedures. For example, the candidate actions could include generating a list of bands in order of signal strength (e.g., measured by the average reference signal receive power RSRP). The candidate actions may also include early failure declaration. For example, past data from the map at a particular location may indicate that once an out-of-sync event happens, the UE is unable to recover, eventually leading to a RLF. In such a case, once an out-of-sync event is detected, it could be beneficial for the UE to declare RLF before waiting for all the relevant timers to expire. In this manner, the UE may start and RLF recovery process sooner (e.g., trying to access another band), which may reduce the impact of the RLF.

At step 530, the UE performs at least one action determined to be a candidate in step 525. For example, the UE may modify the appropriate parameters or configuration list (e.g., the relevant order of desired bands, or some timer values [as in the case of early RLF declaration]).

At step 535, which is optional, the UE monitors the outcome of performing the action and updates map 515 and/or an action selection procedure based on the outcome. For example, monitor the action taken associated with the current event could be used to improve the selection of actions (e.g., the choice of bands). In some embodiments, step 535 may be an action-specific learning process that provides additional information to the map for better selection of the action. For example, in the case of an RLF event, there could be some correlation between RSRQ of the target band and the success rate of the recovery on that band.

Although FIG. 5 illustrates one example method for map exploitation 500, various changes may be made to FIG. 5. For example, while shown as a series of steps, various steps in FIG. 5 could overlap, occur in parallel, occur in a different order, occur any number of times, be omitted, or replaced by other steps.

In the examples described herein, it is assumed that location information is available while performing various embodiments of smart band selection methods. However, the methods described herein may utilize the map without precise location information. Examples of location information may include a GNSS coordinate, (global) cell ID, WiFi SSID for indoor locations, etc. Maps may be generated using only data from an individual UE, which may be referred to as private maps. Maps may also be obtained from data aggregated from a group of UEs, which may be referred to as shared maps. There are some advantages and tradeoffs between using a private map and a shared map. For example, because a private map only uses the data collected by the UE itself, the map generation may be done entirely on the UE device, and the data may never be shared or seen by any other entities. This can avoid privacy concerns, especially since the data may contain location information. However, private maps can only be generated for locations that the user frequents, and therefore it may take longer to obtain an accurate map compared to shared maps. In some embodiments, for shared maps, a third-party service may be utilized to collect the data from the participating UEs, and the third party may use the data to generate the maps. For example, the third-party service may coordinate the data collection across the UEs. Additionally, the third-party service may maintain a set of servers and applications on the participating UE devices. The applications may provide information on which measurements to prioritize based on the latest status of the map since the UEs' last communication with the servers. In other embodiments, the UE may determine such priorities from the map itself similar to the private map building case. In some embodiments, the application may initiate the report of the collected data back to the server, as well as retrieving the latest map update to ensure the local map is up-to-date. The measurement data reporting may be reported in a non-real-time manner. For example, the UE may wait for the appropriate network conditions and UE state (e.g., when no user data is on-going) to perform data reporting to the server. In some embodiments, to avoid potential costs when performing data reporting, the application may only send the data when a WiFi connection is available. With the shared map approach, the burden of data collection per participating UE may be reduced compared to the private map option. Further, shared maps may provide benefits even for the locations where a user may be visiting for the first time.

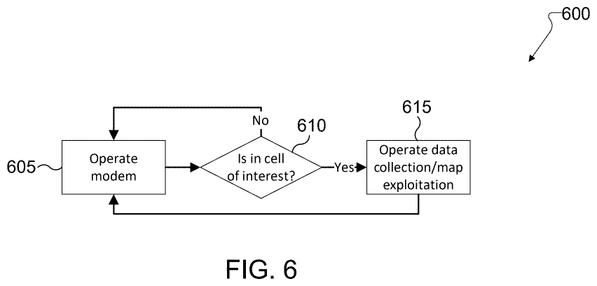

In the examples of FIG. 4 and FIG. 5, the processes associated with methods 400 and 500 are always running. However, in some cases the performance problems which may be mitigated by methods 400 and 500 may be localized, and it may be sufficient to build the maps around the events of interest. This approach is beneficial especially for UEs with battery power constraints because running location services (e.g., a GPS receiver) may consume a non-negligible amount of power. Therefore, some embodiments of methods 400 and 500 may be modified where the processes of methods 400 and 500 are only invoked when the UE is in a cell of interest. For example, methods 400 and 500 may be modified to include the processes shown in FIG. 6. As described herein, a cell of interest refers to a cell where events of interest (e.g., an RLF, HO failure, RA failure, etc.) have been observed to happen consistently.

FIG. 6 illustrates an example method for identifying a cell of interest 600 according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a method for identifying a cell of interest could be used without departing from the scope of this disclosure.

In the example of FIG. 6, method 600 begins at step 605. At step 605, a UE such as UE 116 of FIG. 1 operates its modem (e.g., transceiver[s] 310). Operating the modem at step 605 may be similar as described regarding step 405 of FIG. 4.

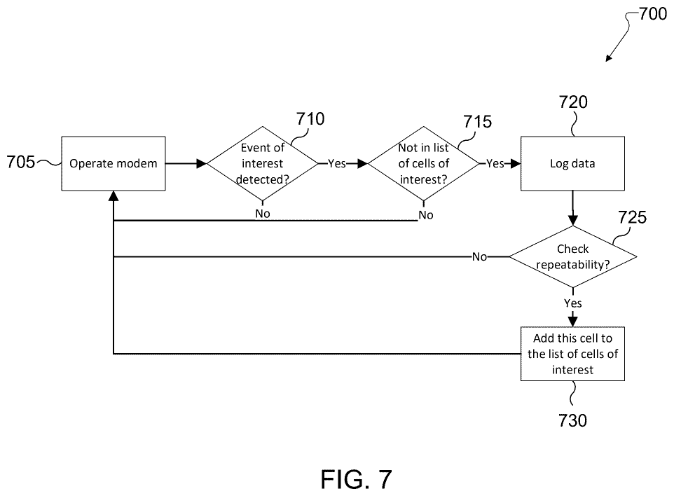

At step 610, the UE determines if a current cell that the UE is operating within is a cell of interest. For example, the UE may check to see if the current cell is listed in a list of cells of interest. To generate the list of cells of interest, the UE may perform method 700 of FIG. 7. If the UE is not operating within a cell of interest, the method returns to step 605. Otherwise, if the UE is operating within a cell of interest, the method proceeds to step 615.

At step 615, the UE performs at least one of data collection operation or a map exploitation operation. For example, at step 615 the UE may perform one or both of method 400 and method 500.

In a cellular network, the cell IDs as well as which cell is the serving cell, and which cells are neighbor cells is readily available to the UE. Each UE is associated with a serving cell, and this serving cell may configure UEs to do measurements of neighboring cells. The UE may also perform a cell search on its own during measurement gaps identified from the current configuration. In a 4G/5G network, the UE may try to detect synchronization signals on the Physical Broadcast Channel (PBCH). Such synchronization signals are broadcast periodically (e.g., every 20, 40, or 80 ms). The synchronization signals may be combined with some additional information. For example, in 5G NR, the synchronization signal blocks (SSBs) carry the synchronization signal and the master information block, which contains the Physical Cell ID (PCI) and information on where the UE may find what is known as the system information block Type 1 (SIB1). SIB1 contains important information for accessing the network which includes a global cell ID (unique ID), schedules of other system information blocks, etc. Thus, a UE always knows which cell it measures from, and which cell is its serving cell.

In some embodiments, the UE may determine whether the UE is operating within a cell of interest based on location information. The location information may be derived from a source other than a GNSS. For example, the cell ID can be used as a rough location indicator that is readily available at the UE without the need to use an external sensor like a GNSS sensor. In some embodiments, the UE determines that the cell is a cell of interest based on a physical cell ID. In some embodiments, the UE determines that the cell is a cell of interest based on a global cell ID.

In some embodiments, the UE may only perform step 615 when the cell is a cell of interest, and an additional condition is met. For example, in some embodiments the UE may perform, signal strength measurements (e.g., RSRP), and only proceed to step 615 when the cell ID corresponds with a cell of interest and the signal strength is weak (e.g., below −110 dBm).

In some embodiments, the UE may determine whether the UE is operating within a cell of interest based on information from neighbor cells. For example, the UE may use a fingerprinting like approach where the signal strengths for the neighboring cells are used as a pattern to identify rough location of interest. The additional information from neighboring cells may provide finer location information than just the cell ID of the current cell (e.g., the east cell-edge could be easily differentiated from the west cell-edge because of the different neighbors at the respective sides).

Although FIG. 6 illustrates one example method for identifying a cell of interest 600, various changes may be made to FIG. 6. For example, while shown as a series of steps, various steps in FIG. 6 could overlap, occur in parallel, occur in a different order, occur any number of times, be omitted, or replaced by other steps.

FIG. 7 illustrates an example method for identifying and registering cells of interest 700 according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a method for identifying and registering cells of interest could be used without departing from the scope of this disclosure.

In the example of FIG. 7, method 700 begins at step 705. At step 705, a UE such as UE 116 of FIG. 1 operates its modem (e.g., transceiver[s] 310). Operating the modem at step 705 may be similar as described regarding step 405 of FIG. 4. During step 705, the UE may detect an occurrent of an event.

At step 710, the UE determines if an event detected during operation of the modem is an event of interest. If the event detected during operation of the modem is not an event of interest, the method returns to step 705. Otherwise, if the event is an event of interest, the method proceeds to step 710.

At step 715, the UE determines whether the cell associated with the event of interest is in a list of cells of interest. For example, the UE may check if the current cell ID is in the list of cells of interest. If the cell is in the list of cells of interest, the method returns to step 705. Otherwise, if the cell is not in the list of cells of interest, the method proceeds to step 720.

At step 720, the data associated with the event are logged. In some embodiments, if the cell has previously been identified as a cell of interest, the data collection process for the map may collect the data.

At step 725, the UE checks against past data to see if this event has happened repeatedly in this cell. Repeatability may be defined in both time and frequency of occurrences. For example, repeatability may be defined as k occurrences among at least N (>k) passes through the location within a 1-month period. If the repeatability condition is not met, then there is not enough evidence to rule out that the event is just a random problem (i.e., not a persistent problem in this cell), and the method returns to step 705. If the repeatability condition is met, then this cell is identified to have persistent problem, and the method proceeds to step 730.

At step 730 the cell is added to the list of cells of interest.

Although FIG. 7 illustrates one example method for identifying and registering cells of interest 700, various changes may be made to FIG. 7. For example, while shown as a series of steps, various steps in FIG. 7 could overlap, occur in parallel, occur in a different order, occur any number of times, be omitted, or replaced by other steps.

As previously described herein, the UE may determine location information from various sources, such as a GNSS or the SSID of a WiFi network.

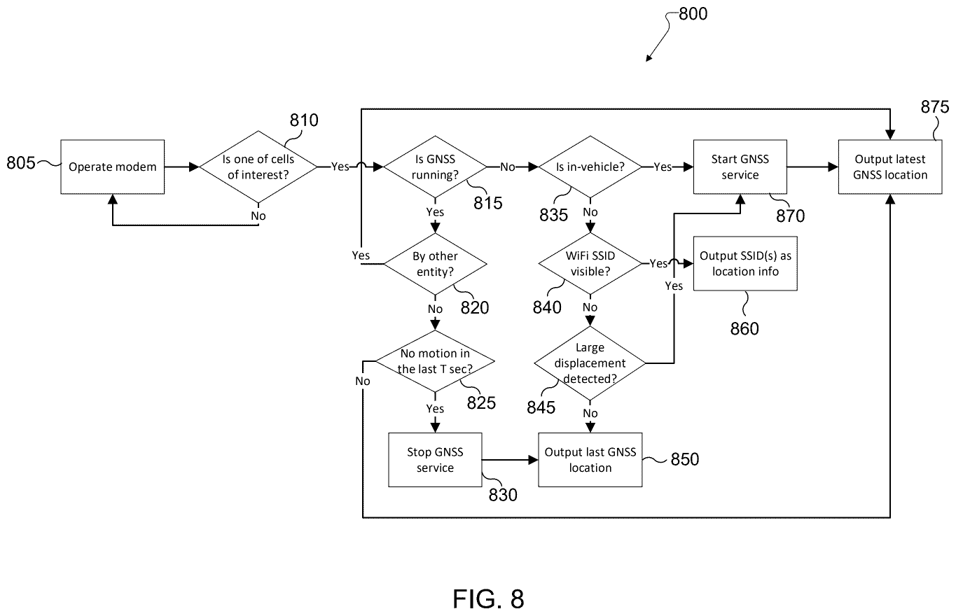

FIG. 8 illustrates an example method for managing location services when in a cell of interest 800 according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a method for managing location services when in a cell of interest could be used without departing from the scope of this disclosure.

Method 800 may minimize use of GNSS service when the GNSS service is not already running for another (e.g., another application or service running on the device). This may help the UE to conserve power resources (e.g., prolong battery life).

In the example of FIG. 8, method 800 begins at step 805. At step 805, a UE such as UE 116 of FIG. 1 operates its modem (e.g., transceiver[s] 310). Operating the modem at step 805 may be similar as described regarding step 405 of FIG. 4.

At step 810, the UE determines if a current cell that the UE is operating within is a cell of interest. For example, the UE may check to see if the current cell is listed in a list of cells of interest. To generate the list of cells of interest, the UE may perform method 700 of FIG. 7. If the UE is not operating within a cell of interest, the method returns to step 805. Otherwise, if the UE is operating within a cell of interest, the method proceeds to step 815.

At step 815, the UE determines whether GNSS service is running. If GNSS service is not running, the method proceeds to step 835. Otherwise, if GNSS service is running, the method proceeds to step 820.

At step 820, the UE determines whether the GNSS service is running for another entity (e.g., another application or service running on the device). If the GNSS service is running for another entity, the method proceeds to step 875. Otherwise, the method proceeds to step 825.

At step 825, the UE determines whether the UE is static. For example, the UE may determine whether the UE has moved within a time threshold T (e.g., the last T seconds). If the UE has moved, the method proceeds to step 875. Otherwise, if the UE has not moved, the method proceeds to step 830.

At step 830, the UE stops the GNSS service.

At step 835, the UE determines whether the UE is in a vehicle. In some embodiments, the UE may use other sensors and side information available on the UE when performing this determination. If the UE is not within a vehicle, the method proceeds to step 840. Otherwise, if the UE is within a vehicle, the method proceeds to step 870.

At step 840, the UE determines whether a WiFi SSID is visible. If a WiFi SSID is not visible, the method proceeds to step 845. Otherwise, if a WiFi SSID is visible, the method proceeds to step 860.

At step 845, the UE checks for recent displacement to determine if the position of the UE is static. For example, the UE may utilize a motion sensor such as an inertial measurement unit (IMU) to determine if a displacement of the UE exceeds a threshold. if the UE detects a large displacement, the method proceeds to step 870. Otherwise, if the UE does not detect a large displacement, the method proceeds to step 850.

At step 850, because the GNSS service is not running, the UE uses the last available location information from the GNSS service while the GNSS was running to perform method 400 and/or 500.

At step 860, the UE utilizes the SSID as location information, and uses the location information based on the SSID to perform method 400 and/or 500. Note that while steps 840 and 860 refer to a WiFi SSID, embodiments of method 800 may utilize other wireless networks instead of or in addition to WiFi. For example, wireless networks such as Bluetooth or other IoT networks may also be used if the target node ID is associated with some fixed location (e.g., if the target node ID is a smart refrigerator or television, it is reasonable to assume the device is fixed). Also, further information related to those networks such as the signal strength (e.g., RSSI) may also be used if available. If such SSIDs are visible to the UE, they can be used as the location information. This is particularly useful for indoor situations where GNSS is unavailable or unreliable.

At step 870, the UE starts GNSS service, as in this situation, the UE is likely to have large displacement, and/or the UE is unlikely to stay in the current cell much longer (e.g., while driving). In some embodiments, (for example, if the cost for starting GNSS is significant) the UE may initiate a timer to avoid frequent turning on/off of the GNSS. For example, when the GNSS is turned on it would stay on until the timer expires before the GNSS can be turned off.

At step 875, the UE takes advantage of the available GNSS service for location information, and uses the latest location information from the GNSS service to perform method 400 and/or 500.

Although FIG. 8 illustrates one example method for managing location services when in a cell of interest, various changes may be made to FIG. 8. For example, while shown as a series of steps, various steps in FIG. 8 could overlap, occur in parallel, occur in a different order, occur any number of times, be omitted, or replaced by other steps.

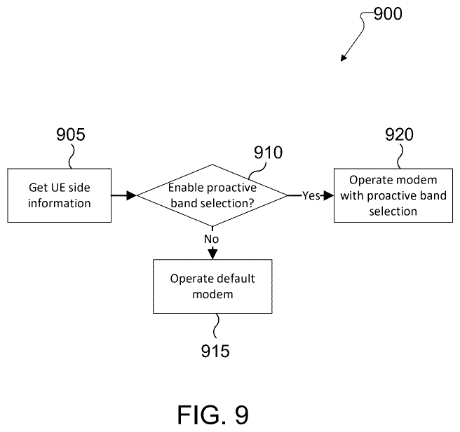

In some cases, location information may be affordable to the UE during operation and the UE may employ a proactive band selection method that utilizes the map. Especially, when using shared maps, the UE have decreased utilization of a location information service, as the burden for map building is distributed among the participating UEs. Furthermore, utilization of the location information service during UE operation may be limited to when the location information is available (e.g., when being used by other apps on the device) or when it is important to maintain good network performance (e.g., avoiding any data communication interruption). To determine when the UE may enable proactive band selection, the UE may perform the method shown in FIG. 9.

FIG. 9 illustrates an example method for managing operation of proactive band selection 900 according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a method for managing operation of proactive band selection 700 could be used without departing from the scope of this disclosure.

In the example of FIG. 9, method 900 begins at step 905. At step 905, a UE such as UE 116 of FIG. 1 gathers side information, which may be used to determine whether to enable proactive band selection. For example, the UE may determine:
whether a location service is enabled by another application on the UE (i.e., location service is available for free from the modem operation perspective)·
whether the UE is plugged in to a power source (e.g., when used in a vehicle).
whether the UE is using a certain type of application (e.g. an application that benefits from low latency and jitter or high throughput).

At step 910, based on the side information gathered in step 905, the UE determines whether to enable proactive band selection. In some embodiments, the UE may also consider a preference of the user. For example, when an application is used for the first time, a pop-up dialog could be displayed to ask for the user's preference whether to enable proactive band selection for optimizing the network performance. If the UE determines not to enable proactive band selection, the method proceeds to step 915. Otherwise, if the UE determines to enable proactive band selection, the method proceeds to step 920.

At step 915, the UE operates its modem (e.g., transceiver[s] 310) according to a default mode. For example, operating the modem at step 915 may be similar as described regarding step 405 of FIG. 4.

At step 920, the UE operates its modem with proactive band selection. For example, the UE may perform methods 400 and/or 500 with some specific steps tailored to proactive band selection. For instance, there may be different objectives for the band selection operation that may depend on the UE's state. For example, during the connected state (e.g., RRC connected state in 4G or 5G networks) depending on the apps, the objective could be:
Maximizing the throughput: e.g., when doing file downloading or when streaming high definition videos.
Minimizing latency and jitter, e.g., when running real-time applications with tight latency such as certain types of mobile gaming.

Although FIG. 9 illustrates one example method for managing operation of proactive band selection 900, various changes may be made to FIG. 9. For example, while shown as a series of steps, various steps in FIG. 9 could overlap, occur in parallel, occur in a different order, occur any number of times, be omitted, or replaced by other steps.

In some embodiments, to maximize the throughput, the best band for any given location may be defined in terms of RSRP and RSRQ. In some embodiments, in addition to or in place of RSRP and RSRQ, the UE may use any other signal quality metrics such as SNR (Signal to Noise Ratio), pathloss, etc. or other interference metrics such as SINR (Signal to Interference/Noise Ratio). In some embodiments, the RSRP may be the average RSRP from the map, while the RSRQ may be measured at the selection time (i.e., instantaneous RSRQ). The average RSRP/RSRQ may be obtained by taking a sample average over all the signal measurements collected for the location. Any variations such as moving average or weighted average to provide more emphasis on recently collected data (i.e., older data have lower weights) may also be used. Note that the candidates from the map could be checked against the current configurations from the network in case some of the bands might not be available. In some embodiments, the band selection method first attempts to measure the RSRQ of the bands with high average RSRP identified using the maps. If the RSRQ is high enough to support the target throughput, then that band is selected. In some other embodiments, the best band with the highest RSRQ is selected. In these situations, the selection is performed only after the measurements of the top k bands (in terms of the average RSRQ) from the map have been completed.

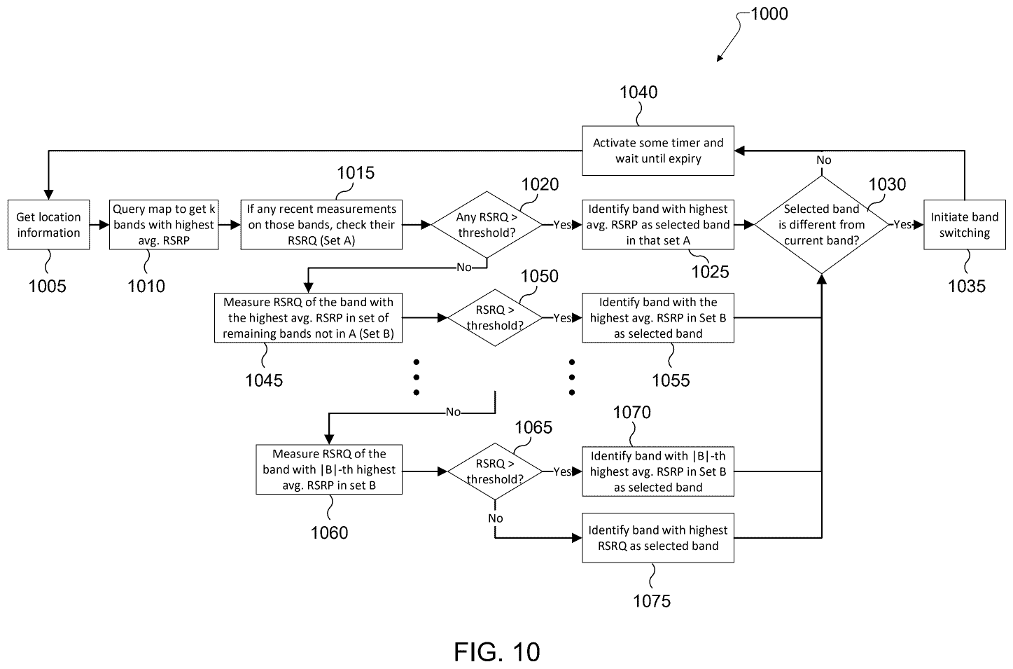

In some embodiments, band selection may be determined by sequential RSRQ measurement as shown in FIG. 10. Sequential RSRQ measurements may allow for a faster band selection decision with some risk that the selected band might not have the highest RSRQ (though the selected band may still be better than a threshold RSRQ). This band selection based on sequential RSRQ measurement may be more suitable for reducing latency, while band selection based on measuring all the k promising bands (in this case high average RSRP from the map) may be more suitable for increasing throughput.

FIG. 10 illustrates an example method for proactive band selection 1000 according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method for proactive band selection could be used without departing from the scope of this disclosure.

In the example of FIG. 10, method 1000 begins at step 1005. At step 1005, a UE such as UE 116 of FIG. 1 that is operating with proactive band selection (e.g., according to step 920 of method 900) gets location information. For example, the location information may be GNSS location information such as from steps 850 or 875 of method 800, or SSID information from step 860 of method 800.

At step 1010, the UE queries a map (e.g., map 430 of FIG. 4 or map 515 of FIG. 5) to get a set “A” of a number of bands “K” with the highest average RSRP associated with the location information. At step 1015, if the UE has any recent measurements on the K bands, the UE checks the RSRQ.

At step 1020, if the RSRQ of any of the K bands exceeds a threshold, the method proceeds to step 1025. Otherwise, if the RSRQ of any of the K bands does not exceed the threshold, the method proceeds to step 1045.

At step 1025, the UE identifies the band from set A that has the highest average RSRP (with RSRQ above the threshold) as a selected band from set A.

At step 1030, the UE determines if the selected band from the previous step is different than the current band the UE is using for operation (e.g., the serving frequency band). If the selected band is the same as the current band, the method proceeds to step 1040. Otherwise, if the selected band is different from the current band, the method proceeds to step 1035.

At step 1035, the UE initiates band switching (i.e., a handover operation) to the selected band evaluated at step 1030. In some embodiments, performance of step 1035 may depend on network support. For example, in some embodiments the network may support UE signaling to initiate a band switching operation. In that case, for some embodiments the UE may send a request to the network indicating the UE's desire to switch to the indicated band. If the network accepts the request, the network may send a command (e.g., something similar to a HO command) to the UE with some additional configurations (e.g., the network may provide RA resource to support contention free RA for the UE). In other embodiments, the network may not provide explicit signaling support. In that case, for some embodiments the UE may disconnect from the network and try to access the desired band (e.g., by initiating a RA procedure on the desired band/cell).

At step 1040, the UE activates a timer, and upon expiration of the timer, the method returns to step 1005.

At step 1045, the UE measures the RSRQ of the band with the highest average RSRP in a set of remaining available bands “B” that are not included in set A. For some embodiments, for measuring the RSRQ, the UE may have to wait for the measurement gaps configured by the network. In some embodiments, to reduce the delay until a band is selected, the UE performs measurements on the promising bands from set B (e.g., with a higher average RSRP) in the order of the availability from the measurement gaps.

At step 1050, if the RSRQ of the band from set B with the highest average RSRP (or alternatively, the band with the highest average RSRP with an available measurement gap to measure the RSRQ in step 1045) is greater than a threshold, the method proceeds to step 1055. Otherwise, the method proceeds to step 1060.

At step 1055, the UE identifies the band measured in step 1045 as a selected band and proceeds to step 1030.

At step 1060, the UE measures the RSRQ of the band with the next highest average RSRP in a set B (or alternatively, the next highest average RSRP with an available measurement gap to measure the RSRQ).

At step 1065, if the RSRQ of the band from set B measured at step 1060 is greater than a threshold, the method proceeds to step 1070. Otherwise, if the RSRQ is not greater than the threshold, if any bands in set B have not had their RSRQ measured, the method returns to step 1060, where the UE measures the RSRQ of the band with the next highest average RSRP in a set B (or alternatively, the next highest average RSRP with an available measurement gap to measure the RSRQ). If the RSRQ of all the bands in set B have been measured and none is above the threshold, the method proceeds to step 1075.

At step 1070, the UE identifies the band measured in step 1065 as a selected band and proceeds to step 1030.

At step 1075 the UE identifies the band in set B with the highest RSRQ as the selected band and proceeds to step 1030.

Although FIG. 10 illustrates one example method for proactive band selection 1000, various changes may be made to FIG. 10. For example, while shown as a series of steps, various steps in FIG. 10 could overlap, occur in parallel, occur in a different order, occur any number of times, be omitted, or replaced by other steps.

In some situations, the present band may sufficiently support data communication of running applications such that minimizing the interruption time, or selecting the best RSRP and/or RSRQ might not be beneficial. For situations such as these, in some embodiments the UE may perform band selection based on past interruption events (e.g., long HO interruption times, RLF rate, etc.) from the map in the vicinity of the current location. For some embodiments, vicinity may be defined to be within a radius from the current location. In other embodiments, vicinity may be defined in terms of the nearby grid points (for example, if the maps use discrete grids), e.g., within some ±N grid points from the current grid point. In some embodiments, the average interruption time of each band within the vicinity region may be computed and used to rank the desired bands. Since interference situation might be more dynamic, some embodiments may include a check on the RSRQ in the same manner as described in regarding FIG. 10.

In some embodiments, during the idle state (e.g., the RRC-idle in 4G or RRC-idle/RRC-inactive in 5G), the UE may perform band selection in some situations. In some embodiments, since there is no demand from an application during an idle state, idle state band selection may be limited to when the UE is plugged in to a power source or when location service is enabled by another application (e.g., a navigation application). In some embodiments, band selection during an idle state may be based on:
Selecting bands with low interruption time/failure rate as the desired band to camp on. In this manner, when data communication starts and the UE transitions to a connected state, the UE would experience good service quality.
Selecting bands with high connection success rates (i.e., successfully transitioning to connected state) and/or with short time to get to the connected state (i.e., short expected initial access time).

In some embodiments, idle state band selection may be performed similar to the connected state band selection methods described herein. However, some embodiments may incorporate additional band selection considerations. For example, to minimize excessive cell reselection, a larger vicinity than a connected state vicinity may be defined.

Radio link failure (RLF) is a common problem in cellular networks. Map-based band selection as described herein may be used to mitigate the impact of an RLF event. Unlike earlier embodiments described herein where band switching is proactive, some embodiments of the band switching methods described herein are reactive in nature. In some embodiments, performing band switching to mitigate RLF may include the following two components:
Band selection for fast link recovery leveraging the map
Early RLF detection leveraging the information from the map.

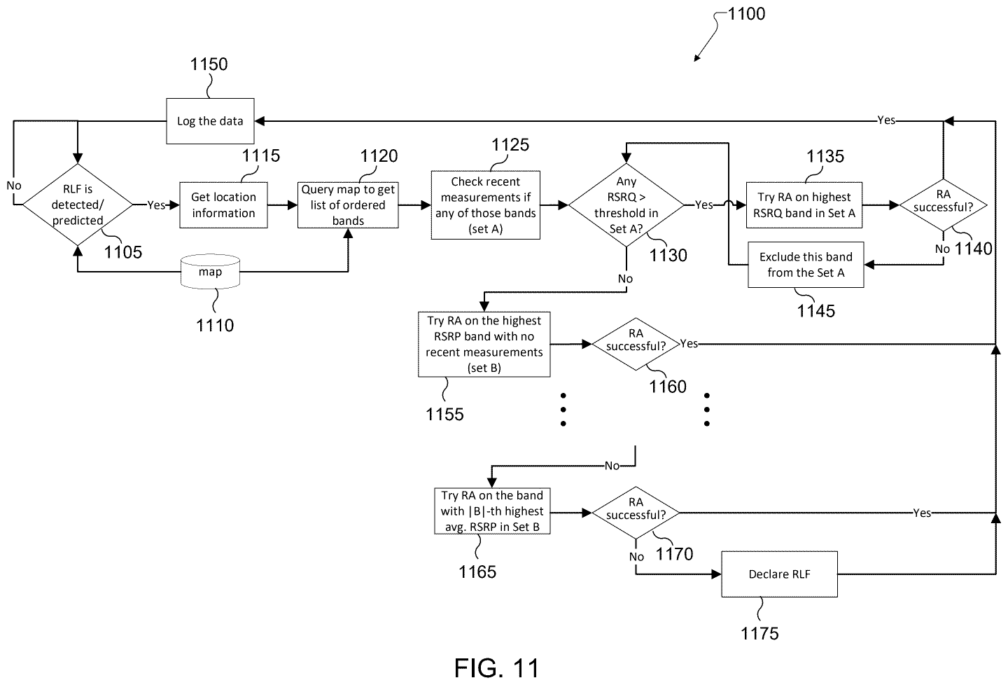

In some embodiments, for band selection for fast link recovery, a similar approach to method 1000 of FIG. 10 may be employed, where average RSRP information from the map (or even just the order of the bands in terms of the average RSRP) is utilized to select a band. For example, the UE may already be in an RLF or an early stage of RLF, where the UE might be unable to communicate with the base station. As such, measuring the RSRQ before attempting the RA to reestablish the link on the band may not be beneficial. An example method employing such techniques is shown in FIG. 11.

FIG. 11 illustrates an example method for band selection for fast RLF recovery 1100 according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a method for band selection for fast RLF recovery could be used without departing from the scope of this disclosure.

In the example of FIG. 11, method 1100 begins at step 1105. At step 1105, a UE such as UE 116 of FIG. 1 determines whether an RLF is detected or predicted. For example, the UE may predict an RLF based on data from map 1110. If an RLF is not detected or predicted, the method returns to step 1105. Otherwise, if the UE detects or predicts an RLF, the method proceeds to step 1115.

At step 1115, the UE gets location information. For example, the location information may be GNSS location information such as from steps 850 or 875 of method 800, or SSID information from step 860 of method 800.

At step 1120, the UE queries map 1110 to get a list of ordered bands. In some embodiments, the order of the list is based on average RSRP. In some embodiments the ordered list of bands may not include all the bands that have been observed in the data collected for generation of map 1110. For example, bands that are not promising (e.g., very poor RSRP) may be excluded. In some embodiments, the ordered list may be limited in size to just a few bands to limit the performance impact of method 1100 in the case map 1110 has inaccurate information (e.g., due to contaminated or outdated data). It should also be understood that while method 1100 is described with respect to bands, method 1100 may be utilized for other RLF recovery scenarios. For example, the list in step 1120 may provide a list of radio access technologies (RATs) instead of a list of bands, and UE may attempt RA with a different RAT in the steps of method 1100 rather than with a different band.

At step 1125, the UE checks for bands with recent measurements to check their RSRQ. In the example of FIG. 11, these bands are denoted as set “A.” In some embodiments, if there are available bands with recent measurements that are not in the map (e.g., new bands that are not in the map due to recent deployment of the bands), they are also included in set A.

At step 1130, the UE checks to see if any of the bands in set A have an already measured RSRQ greater than a threshold. If any of the bands in set A have an RSRQ that exceeds the threshold, the method proceeds to step 1135. Otherwise, if none of the bands in set A have an RSRQ that exceeds the threshold, the method proceeds to step 1155.

At step 1135, the UE attempts a random access (RA) on the band in set A with the highest RSRQ and proceeds to step 1140. At step 1140, the UE determines if the RA attempt was successful. If the RA attempt was successful, the method proceeds to step 1150. Otherwise, if the RA attempt was unsuccessful, the method proceeds to step 1145.

At step 1145, the UE excludes the band on which RA was attempted at step 1135 from set A and the method returns to step 1130.

At step 1150, the UE logs data related to the RLF recovery outcome in map 1110 and resumes its data communication. The logged data may be used for future learning to improve band selection. For example, if the outcome data has been collected enough times, in some embodiments the success rate of the recovery of the bands may be computed. Then, the success rate may be used for ordering the bands instead of the average RSRP, and the check on RSRQ may be kept the same at steps 1125-1130. Some embodiments may also consider duration to recovery as part of the logged data. For example, if it takes longer than a threshold (e.g., 100 ms) to complete a link establishment on a particular band (e.g., at step 1140), it may be regarded as a failure for the purpose of band selection when the data is logged.

If none of the bands in set A have an RSRQ that exceeds a threshold, or if none of the bands in set A have a successful RA attempt at step 1140, then at step 1155, the UE performs an RA attempt on the highest RSRP band with no recent measurements and proceeds to step 1160. In the example of FIG. 11, the available bands with no recent measurements are denoted as set “B.”

At step 1160, the UE determines if the RA attempt was successful. If the RA attempt was successful, the method proceeds to step 1150. Otherwise, if the RA attempt was unsuccessful, the method proceeds to step 1165.

At step 1165, the UE performs an RA attempt on the next highest RSRP band with no recent measurements and proceeds to step 1170.

At step 1170, the UE determines if the RA attempt was successful. If the RA attempt was successful, the method proceeds to step 1150. Otherwise, if the RA attempt was unsuccessful and if set B includes any band on which an RA attempt has not been attempted, the method returns to step 1165. If an RA attempt has been attempted and failed on all of the bands in set B, the method proceeds to step 1175.

At step 1175, the UE declares an RLF failure, and the method proceeds to step 1150.

Although FIG. 11 illustrates one example method for band selection for fast RLF recovery 1100, various changes may be made to FIG. 11. For example, while shown as a series of steps, various steps in FIG. 11 could overlap, occur in parallel, occur in a different order, occur any number of times, be omitted, or replaced by other steps.

An early detection of an RLF by a UE may be beneficial, as the UE could begin the recovery process earlier, minimizing the overall interruption time of the RLF. Not all RLFs can be detected early, but for some cases, it may be possible to do so using the information in the map. One example is the case where the RLF is due to poor link condition (typically in 4G/5G, this could be identified as RLF due to T310 expiry). To avoid false alarms without much side information, 3GPP standards often define quite loose timers to detect an RLF. In some deployments, such timers may be set to several seconds. However, with the past measurements recorded in the map, a poor link quality region may be known to the UE. That is to say, the UE may use the map data to be sure that the RLF is not due to a random fluctuation such as a fading event, and an RLF due to poor link condition could be detected without waiting for expiration of a timer.

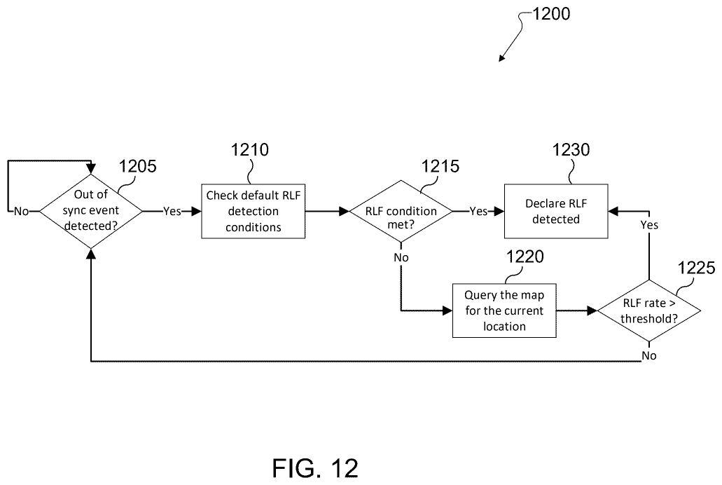

Poor link quality is often defined as an out of sync event, where the signal quality (e.g., RSRP or RSRQ) is below a threshold such that the UE is unable to communicate with the base station. An out-of-sync event is often the first phase of an RLF event. In some standards such as those published by 3GPP, a number “N” of consecutive out-of-sync events are used as a predicate to start a timer for determining an RLF event. In some embodiments, given the current number of consecutive out-of-sync events, the UE can query the map to get the RLF rate for the current band. In some embodiments, one out of sync event might be sufficient for the UE to declare RLF, while in other embodiment multiple out of sync events might be required to declare RLF using the map. An example method for an early detection of an RLF utilizing such techniques is shown in FIG. 12.

FIG. 12 illustrates an example method for early detection of an RLF 1200 according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a method for earl detection of an RLF could be used without departing from the scope of this disclosure.

In the example of FIG. 12, method 1200 begins at step 1205. At step 1205, a UE such as UE 116 of FIG. 1 determines whether an out of sync event is detected. If an out of sync event is not detected, the method returns to step 1205. Otherwise, if the UE detects an out of sync event, the method proceeds to step 1210.

At step 1210, the UE checks default RLF detection conditions and proceeds to step 1215. At step 1215, the UE checks to see if an RLF condition is met. If an RLF condition is met, the method proceeds to step 1230. Otherwise, if an RLF condition is not met, the method proceeds to step 1220.

At step 1220, the UE queries a map (e.g., map 430 of FIG. 4 or map 515 of FIG. 5) for RLF map data for the current location of the UE and proceeds to step 1225. For example, in some locations one particular band may have very low RSRP in the area, so that there is a high probability that an out of sync event would lead to an RLF event. In other cases, it could happen that the RSRP for the band is still relatively strong, but the RSRQ is poor. In that case, the situation could improve after some time duration. In some embodiments, the UE may observe from the map the failure rate after observing k consecutive out-of-sync events at that location. In some embodiments, when querying the map to determine the RLF rate, the speed of the UE may be considered. For example, the data recorded in the map may indicate the RLF rate at that location given the speed and the number of consecutive out-of-sync events observed so far. In some embodiments, the speed of the UE may be obtained from a motion sensor such as an IMU sensor. In some embodiments, the UE speed could be provided from a location service (e.g., a GNSS).

At step 1225, the UE determines whether the RLF rate at the current location exceeds a threshold. If the RLF rate does not exceed the threshold, the method returns to step 1205. Otherwise, if the RLF rate exceeds the threshold, the method proceeds to step 1230.

At step 1230, the UE declares that an RLF is detected.

Although FIG. 12 illustrates one example method for early detection of an RLF 1200, various changes may be made to FIG. 12. For example, while shown as a series of steps, various steps in FIG. 12 could overlap, occur in parallel, occur in a different order, occur any number of times, be omitted, or replaced by other steps.

Another type of event of interest relates to handover (HO), which may include HO failures and HOs with a larger than usual interruption time (typical numbers for 4G are 30-60 ms). In the examples described in the present disclosure, this event type is referred to as an HO failure (HOF). A mitigation approach for an HOF can be similar to that of an RLF. In some embodiments, for fast recovery from an HOF, the band selection procedure of FIG. 11 may be used. Similarly to RLF, in some cases, an early HOF may be detectable using the map, which in some embodiments may allow for the UE to perform an early start to try to connect to the (correct) target cell, thus reducing the overall interruption time. HOF may happen at different stages, which may include:
Case 1: UE sent a measurement report (which in normal conditions would trigger a HO), but it never received a HO command from the base station. This could be due to the base station not receiving the measurement report (i.e., a HO command was never sent) or the UE did not receive the HO command due to a bad link condition.
Case 2: Failure during the RA, where the UE sent an RA preamble, but the UE never received an RA response from the target cell.

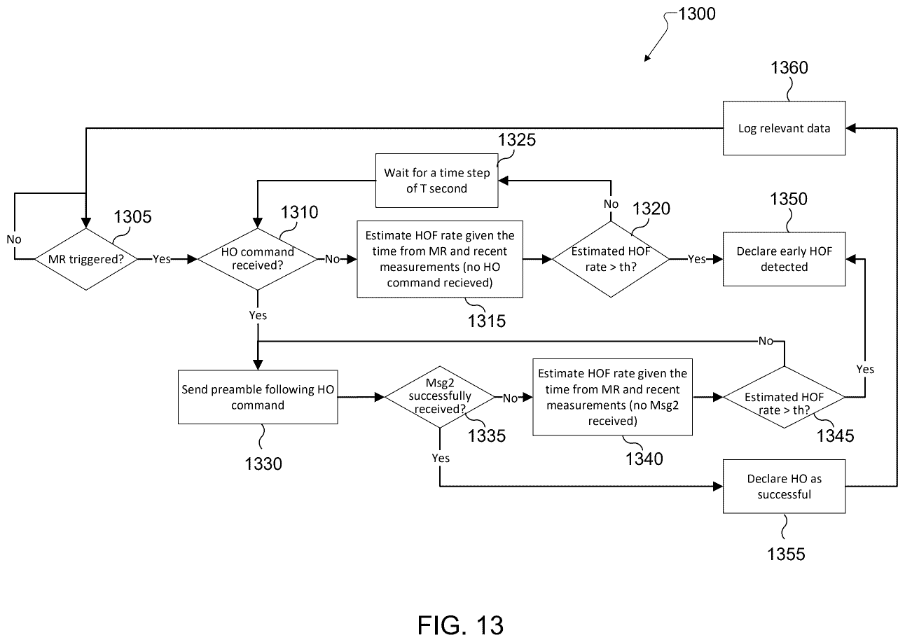

In some embodiments, early HOF detection may be established for the two stages of failure as in Case 1 and Case 2, similarly as shown in FIG. 13.

FIG. 13 illustrates an example method for early HOF detection 1300 according to embodiments of the present disclosure. An embodiment of the method illustrated in FIG. 1300 is for illustration only. One or more of the components illustrated in FIG. 1300 may be implemented in specialized circuitry configured to perform the noted functions or one or more of the components may be implemented by one or more processors executing instructions to perform the noted functions. Other embodiments of a method for early HOF detection could be used without departing from the scope of this disclosure.

In the example of FIG. 13, method 1300 begins at step 1305. At step 1305, a UE such as UE 116 of FIG. 1 determines whether there is a measurement report (MR) with results that would lead to HO in typical cases (e.g., when the signal strength of a neighboring cell is greater than that of the serving cell by a certain threshold). If such an MR is not detected, the method returns to step 1305. Otherwise, the method proceeds to step 1310.

At step 1310, the UE determines whether an HO command has been received from the base station. The longer the duration that the UE has not received an HO command after the MR, the more likely it is that this is a failure event. If an HO command has been received, the method proceeds to step 1330. Otherwise, if an HO command has not been received (or not received within a particular period of time), the method proceeds to step 1315.

At step 1315, utilizing data from a map (e.g., map 430 of FIG. 4 or map 515 of FIG. 5), the UE estimates the HOF rate given the current situation. In some embodiments, the map data may include the time since the MR and any recent measurements of the signal strength (e.g., RSRP/RSRQ) of the current cell. In some embodiments, the UE's mobility information (e.g., the speed) may also be used for HOF rate estimation.

At step 1320, the UE determines whether the estimated HOF rate exceeds a threshold. If the estimated HOF rate exceeds the threshold, the method proceeds to step 1350. Otherwise, if the estimated HOF rate does not exceed the threshold, the method proceeds to step 1325.

If the estimated HOF rate is not high (i.e., does not exceed the threshold at step 1320) this indicates that there is not enough evidence from the map to determine that HOF is likely, and at step 1325, the UE continues to wait to receive an HO command for a time step of “T” seconds.

If an HO command is received, then at step 1330, the UE performs an RA attempt by sending a preamble (Msg1) following the configurations provided by the HO command. If this step is successful, UE is expected to successfully receive the RA response (or Msg2) within the RA response window (configured by the network).

At step 1335, the UE determines whether a Msg2 was received within the RA response window. If no Msg2 is received within the window, this RA attempt fails, and the method proceeds to step 1340. If a Msg2 is received within the window, the method proceeds to step 1355 where the UE declares the HO as successful.

At step 1340, utilizing data from a map (e.g., map 430 of FIG. 4 or map 515 of FIG. 5), the UE estimates the HOF rate given the current situation. In some embodiments, the map data may include one or more of recent available measurements, mobility information, the current number of unsuccessful trials of preamble transmission, and the like.

At step 1345, the UE determines whether the estimated HOF rate exceeds a threshold. If the estimated HOF rate exceeds the threshold, the method proceeds to step 1350. Otherwise, if the estimated HOF rate does not exceed the threshold, the method returns to step 1330. In some embodiments, steps 1330-1345 may be repeated for a certain number of RA trials provided by the network.

At step 1350, the UE declares that an early HOF is detected and may start a recovery procedure. For example, in some embodiments, the UE may attempt to establish a link to a promising target cell.

At step 1360, relevant data is saved in the map for future improvement or adaptation of the estimate of the HOF for this location, and the method returns to step 1305.

Although FIG. 13 illustrates one example method for early HOF detection 1300, various changes may be made to FIG. 13. For example, while shown as a series of steps, various steps in FIG. 13 could overlap, occur in parallel, occur in a different order, occur any number of times, be omitted, or replaced by other steps.

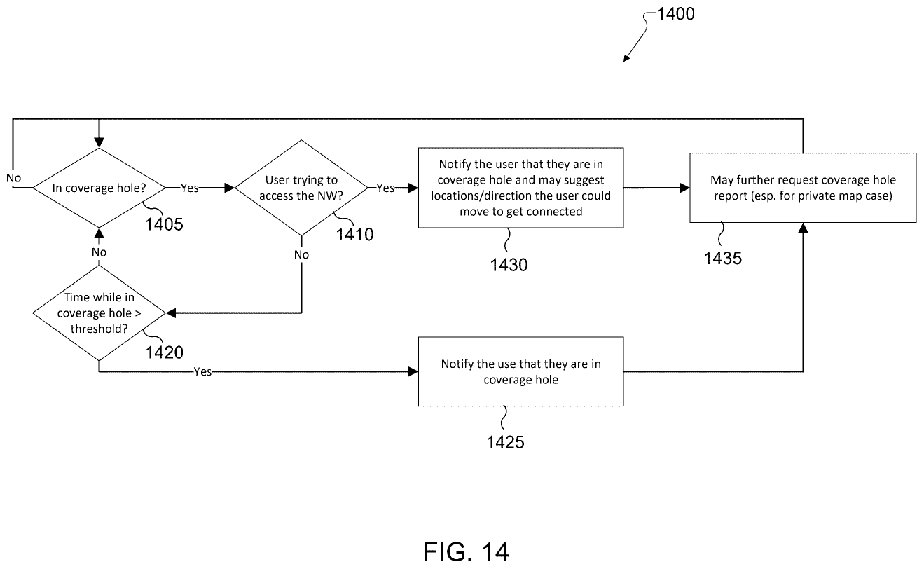

Another event of interest is when the UE enters a coverage hole. In the examples of the present disclosure, a coverage hole refers to a location where there are no cells with an RSRP larger than some detectable value (e.g., −124 dBm). When the UE is in a coverage hole, it may not be possible for the UE to recover without the UE moving out of the coverage hole area. An example method to notify a user of the UE that the UE is in a coverage hole is shown in FIG. 14. In this manner, the user may relocate the UE to an area outside of the coverage hole so that the UE may recover.

FIG. 14 illustrates an example method for coverage hole mitigation 1400 according to embodiments of the present disclosure. An embodiment of the method illustrated in FIG. 1400 is for illustration only. One or more of the components illustrated in FIG. 14 may be implemented in specialized circuitry configured to perform the noted functions or one or more of the components may be implemented by one or more processors executing instructions to perform the noted functions. Other embodiments of a method for coverage hole mitigation could be used without departing from the scope of this disclosure.

In the example of FIG. 14, method 1400 begins at step 1405. At step 1405, a UE such as UE 116 of FIG. 1, utilizing data from a map (e.g., map 430 of FIG. 4 or map 515 of FIG. 5), determines whether the UE is in a coverage hole. If the UE is not within a coverage hole, the method returns to step 1405. Otherwise, if the UE is within a coverage hole, the method proceeds to step 1410.

At step 1410, the UE determines whether a user of the UE is trying to access the network. If the user is not trying to access the network, the method proceeds to step 1420. Otherwise, if the user is trying to access the network, the method proceeds to step 1430.

At step 1420, the UE determines whether the UE has been within the coverage hole for a duration exceeding a threshold. If the time has not exceeded a threshold, the method returns to step 1405. Otherwise, if the time has exceeded the threshold, the method proceeds to step 1425.

At step 1425, the UE notifies the user that they are in a coverage hole. For example, in some embodiments, the UE may display a popup dialog notification to inform them that the current location is a known coverage hole and that they need to move to a different location for the coverage. In some embodiments, suggestions of which direction or locations the user could move might also be provided. The method may then optionally proceed to step 1435. Otherwise, the method may return to step 1405.

At step 1430, the UE notifies the user that they are in a coverage hole. For example, in some embodiments, the UE may display a popup dialog notification to inform them that the current location is a known coverage hole and that they need to move to a different location for the coverage. In some embodiments, suggestions of which direction or locations the user could move might also be provided. The method may then optionally proceed to step 1435. Otherwise, the method may return to step 1405.

In some embodiments, at step 1435, the UE may request permission to log the coverage hole event with a third party. In some events, the request may be sent when the map is a private map. In some embodiments, data related to the coverage hole event may be aggregated for the benefit of other users, or to help the network operator solve coverage issues.

Although FIG. 14 illustrates one example method for coverage hole mitigation 1400, various changes may be made to FIG. 14. For example, while shown as a series of steps, various steps in FIG. 14 could overlap, occur in parallel, occur in a different order, occur any number of times, be omitted, or replaced by other steps.

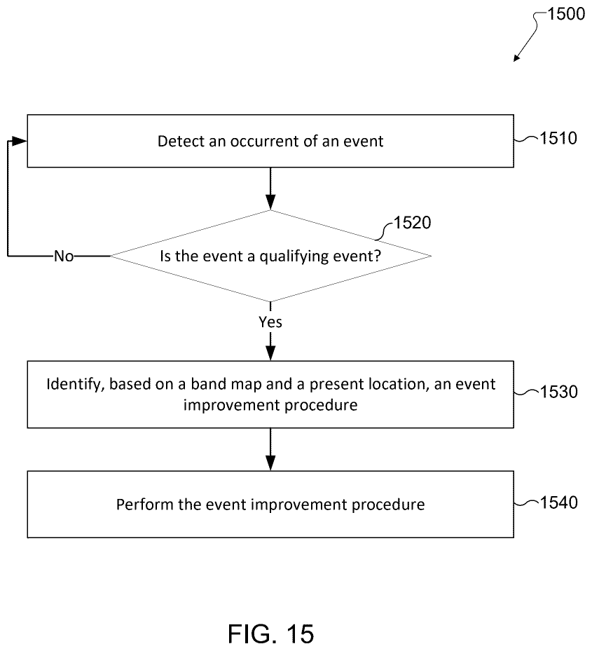

FIG. 15 illustrates an example method for UE smart band selection 1500 according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a method for UE smart band selection could be used without departing from the scope of this disclosure.

In the example of FIG. 15, method 1500 begins at step 1510. At step 1510, a UE such as UE 116 of FIG. 1 detects an occurrent of an event. For example, the event may be an event as previously described herein, such as a RLF or an HOF. However, the event may be any event detectable by the UE.

At step 1520, the UE determines whether the event is a qualifying event. For example, the qualifying event may be similar as previously described herein, such as a RLF or an HOF. However, any event detectable by the UE may be a qualifying event, according to the configuration of the UE. If the UE determines that the event is a qualifying event, the method proceeds to step 1530.

In some embodiments, the UE determines whether a current cell is a cell of interest, and the UE determines that the event is not a qualifying event when the current cell is not a cell of interest. For example, the UE may determine whether the cell is a cell of interest according to method 600.

In some embodiments, the UE determines whether the event is an event of interest, and in response to a determination that the event is an event of interest, determines whether determining whether a current cell is listed in a cell of interest list. For example, the UE may perform method 700. In some embodiments, in response to a determination that the current cell is not listed within the cell of interest, the UE updates the band map, and determines whether to add the current cell to the cell of interest list.

In some embodiments, the UE determines whether the event is an event of interest, and in response to a determination that the event is an event of interest, and selects, via a location information source selection procedure, a location information source. For example, the UE may perform method 800. In some embodiments, the selected location information source exploits readily available context at the UE to reduce direct query to a location sensor. In some embodiments, the UE determines (e.g., at step 1530) via the selected location information source, the present location of the UE.

At step 1530, the UE identifies, based on a band map (e.g., map 430 of FIG. 4 or map 515 of FIG. 5) and a present location of the UE, an event improvement procedure. For example, the event improvement procedure may be one or more of methods 1000, 1100, 1200, 1300, and 1400 described herein. However, the event improvement procedure may be any event improvement procedure known to the UE.

In some embodiments, the UE generates the band map. In some embodiments, to generate the band map, the UE determines whether a first measurement is available. In some embodiments, in response to a determination that the first measurement is available, the UE determines whether the first measurement is useful for updating the band map. In some embodiments, the in response to a determination that the first measurement is useful for updating the band map, the UE updates the band map based on the first measurement. In some embodiments, after updating the band map with the first measurement, the UE determines whether adaptive measurement is enabled. In response to a determination that adaptive measurement is enabled, the UE identifies an opportunity for a second measurement, and identifies whether second measurement is useful for updating the band map. In some embodiments, in response to a determination that the second measurement is useful for updating the band map, the UE performs a procedure associated with updating the band map based on the second measurement.

At step 1540, the UE performs the event improvement procedure. In some embodiments, the event may be expiration of a timer, and the event improvement procedure may include the UE identifying, based on the band map and the present location of the UE, a set of candidate bands, and selecting, based on a signal quality metric, a candidate band from the set of candidate bands. When the candidate band is different than the current band, the UE may initiate a band switching procedure. In some embodiments, the UE may, based on UE side information, start the timer prior to the occurrent of the event.

In some embodiments, the event may be a detection or a prediction of one of an RLF an HOF, and the event improvement procedure may include the UE identifying, based on the band map and the present location of the UE, a set of candidate bands, selecting, based on a signal quality metric, a candidate band from the set of candidate bands, performing a random access (RA) on the candidate band, and updating the band map based on a result of the RA. In some embodiments, when the RA on the candidate band is not successful, the UE may exclude the candidate band from the set of candidate bands, and determine whether an alternative candidate band is available in the set of candidate bands. When the alternative candidate band is available, the UE may perform an RA on the alternative candidate band, and when the alternative candidate band is not available, the UE may declare the RLF or the HOF.

Although FIG. 15 illustrates one example method for UE smart band selection 1500, various changes may be made to FIG. 15. For example, while shown as a series of steps, various steps in FIG. 15 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver; and
a processor operably coupled to the transceiver, the processor configured to:
detect an occurrent of an event;
determine whether the event is a qualifying event; and
in response to a determination that the event is a qualifying event:
identify, based on a band map and a present location of the UE, an event improvement procedure; and
perform the event improvement procedure.

2. The UE of claim 1, wherein:
the processor is further configured to generate the band map; and
to generate the band map, the processor is further configured to:
determine whether a first measurement is available;
in response to a determination that the first measurement is available, determine whether the first measurement is useful for updating the band map; and
in response to a determination that the first measurement is useful for updating the band map, update the band map based on the first measurement.

3. The UE of claim 2, wherein the processor is further configured to, after updating the band map with the first measurement:
determine whether adaptive measurement is enabled; and
in response to a determination that adaptive measurement is enabled:
identify an opportunity for a second measurement;
identify whether second measurement is useful for updating the band map; and
in response to a determination that the second measurement is useful for updating the band map, perform a procedure associated with updating the band map based on the second measurement.

4. The UE of claim 1, wherein the processor is further configured to:
determine whether a current cell is a cell of interest; and
determine that the event is not a qualifying event when the current cell is not a cell of interest.

5. The UE of claim 1, wherein the processor is further configured to:
determine whether the event is an event of interest; and
in response to a determination that the event is an event of interest:
determine whether a current cell is listed in a cell of interest list; and
in response to a determination that the current cell is not listed within the cell of interest:
update the band map; and
determine whether to add the current cell to the cell of interest list.

6. The UE of claim 1, wherein the processor is further configured to:
determine whether a current cell is a cell of interest; and
in response to a determination that the current cell is a cell of interest:
select, via a location information source selection procedure, a location information source, wherein the selection exploits readily available context at the UE to reduce direct query to a location sensor; and
determine via the selected location information source, the present location of the UE.

7. The UE of claim 1, wherein:
the event is expiration of a timer; and
to perform the event improvement procedure, the processor is further configured to:
identify, based on the band map and the present location of the UE, a set of candidate bands;
select, based on a signal quality metric, a candidate band from the set of candidate bands; and
when the candidate band is different than a current band, initiate a band switching procedure.

8. The UE of claim 7, wherein the processor is further configured to:
determine UE side information, and
prior to occurrence of the event, start, based on the UE side information, the timer.

9. The UE of claim 1, wherein:
the event is a detection or a prediction of one of a radio link failure (RLF) and a handover failure (HOF); and
to perform the event improvement procedure, the processor is further configured to:
identify, based on the band map and the present location of the UE, a set of candidate bands;
select, based on a signal quality metric, a candidate band from the set of candidate bands;
perform a random access (RA) on the candidate band; and
update the band map based on a result of the RA.

10. The UE of claim 9, wherein the processor is further configured to, when the RA on the candidate band is not successful:
exclude the candidate band from the set of candidate bands;
determine whether an alternative candidate band is available in the set of candidate bands;
when the alternative candidate band is available, perform an RA on the alternative candidate band; and
when the alternative candidate band is not available, declare the RLF or the HOF.

11. A method of operating a user equipment (UE), the method comprising:
detecting an occurrent of an event;
determining whether the event is a qualifying event; and
in response to a determination that the event is a qualifying event:
identifying, based on a band map and a present location of the UE, an event improvement procedure; and
performing the event improvement procedure.

12. The method of claim 11, further comprising:
generating the band map,
wherein to generate the band map, the method further comprises:
determining whether a first measurement is available;
in response to a determination that the first measurement is available, determining whether the first measurement is useful for updating the band map; and
in response to a determination that the first measurement is useful for updating the band map, updating the band map based on the first measurement.

13. The method of claim 12, further comprising, after updating the band map with the first measurement:
determining whether adaptive measurement is enabled; and
in response to a determination that adaptive measurement is enabled:
identifying an opportunity for a second measurement;
identifying whether second measurement is useful for updating the band map; and
in response to a determination that the second measurement is useful for updating the band map, performing a procedure associated with updating the band map based on the second measurement.

14. The method of claim 11, further comprising:
determining whether a current cell is a cell of interest; and
determining that the event is not a qualifying event when the current cell is not a cell of interest.

15. The method of claim 11, further comprising:
determining whether the event is an event of interest; and
in response to a determination that the event is an event of interest:
determining whether a current cell is listed in a cell of interest list; and
in response to a determination that the current cell is not listed within the cell of interest:
updating the band map; and
determining whether to add the current cell to the cell of interest list.

16. The method of claim 11, further comprising:
determining whether a current cell is a cell of interest; and
in response to a determination that the current cell is a cell of interest:
selecting, via a location information source selection procedure, a location information source, wherein the selection exploits readily available context at the UE to reduce direct query to a location sensor; and
determining via the selected location information source, the present location of the UE.

17. The method of claim 11, wherein:
the event is expiration of a timer; and
to perform the event improvement procedure, the method further comprises:
identifying, based on the band map and the present location of the UE, a set of candidate bands;
selecting, based on a signal quality metric, a candidate band from the set of candidate bands; and
when the candidate band is different than a current band, initiate a band switching procedure.

18. The method of claim 17, further comprising:
determining UE side information, and
prior to occurrence of the event, starting, based on the UE side information, the timer.

19. The method of claim 11, wherein:
the event is a detection or a prediction of one of a radio link failure (RLF) and a handover failure (HOF); and
to perform the event improvement procedure, the method further comprises:
identifying, based on the band map and the present location of the UE, a set of candidate bands;
selecting, based on a signal quality metric, a candidate band from the set of candidate bands;
performing a random access (RA) on the candidate band; and
updating the band map based on a result of the RA.

20. The method of claim 19, further comprising, when the RA on the candidate band is not successful:
excluding the candidate band from the set of candidate bands;
determining whether an alternative candidate band is available in the set of candidate bands;
when the alternative candidate band is available, performing an RA on the alternative candidate band; and
when the alternative candidate band is not available, declaring the RLF or the HOF.
